(19) United States
(12) Patent Application Publication
(10) Pub. No.: US 2012/0079289 A1
(43) Pub. Date: Mar. 29, 2012

(54) SECURE ERASE SYSTEM FOR A SOLID STATE NON-VOLATILE MEMORY DEVICE

(75) Inventors: Wu Kun WENG, Hsinchu City (TW); Hsin Hsien WU, Hsinchu City (TW)

(73) Assignee: SKYMEDI CORPORATION, Hsinchu City (TW)

(21) Appl. No.: 12/891,631

(22) Filed: Sep. 27, 2010

(51) Int. Cl. G06F 12/14; H04L 9/00; G06F 12/00

(52) U.S. Cl. 713/193; 711/103; 380/44; 711/E12.001; 711/E12.092

(57) ABSTRACT

A secure erase system for a solid state memory device is disclosed. A memory area provides a data block for storing data and a key block for storing at least one key. A translation unit maps a logical address to a physical address associated with the memory area. An encryption unit encrypts plaintext data to be written to the memory area with the associated key and decrypts the encrypted data to be read by a host with the associated key. The key associated with a logical erase group to be secure erased is deleted after receiving a command requesting to erase the data associated with the logical erase group.

### BACKGROUND OF THE INVENTION

1. Field of the Invention

The present invention generally relates to a solid state memory device, and more particularly to a secure erase system for a solid state non-volatile memory device.

2. Description of Related Art

Flash memory is a non-volatile solid state memory device that can be electrically erased and reprogrammed. As the flash memory has become popular with modern electronic systems, data security for the flash memory comes out to be a major concern.

Most operating systems do not delete data from the flash memory when an erase or delete command is received. Instead, only the link or the address is removed or modified, while the actual data remains intact in the flash memory until the data area is erased actually. Before the erasing, the remained data may be retrieved or recovered by an intruder.

Accordingly, a secure erase (or data wiping) procedure is urged by many systems to thoroughly erase the data when a secure erase command is received. Conventional secure erase technique is commonly adapted to a file or disk system, in which the link (or pointer) has a one-to-one correspondence with the data to be erased. Therefore, the data associated with the link to be erased may be straightforward and quickly erased. However, such conventional secure erase technique oftentimes cannot be adapted to a solid state non-volatile memory device such as the flash memory for the reason that a single link (or logical-to-physical mapping) may corresponds to multiple data groups in the flash memory. Erasing all the data groups will consume a substantive amount of time and it may be a complicated task to search out all the data groups, either of which probably makes the secure erase difficult or even impractical.

For the reason that conventional secure ease procedure cannot be well adapted to the solid state non-volatile memory, a need has arisen to propose a novel secure erase system that is capable of quickly and effectively secure erasing data in the non-volatile memory.

### SUMMARY OF THE INVENTION

In view of the foregoing, it is an object of the embodiment of the present invention to provide a secure erase system for a solid state memory device that can substantially decrease secure erase time while assure that the erased data can no longer be recovered, thereby securing and protecting the data from being intruded.

According to one embodiment, a secure erase system for a solid state memory device includes a memory area, a translation unit and an encryption unit. The memory area provides a data block for storing data and a key block for storing at least one key. The translation unit is configured to map a logical address to a physical address associated with the memory area. The encryption unit is configured to encrypt plaintext data to be written to the memory area with the associated key and decrypt the encrypted data to be read by a host with the associated key. The key associated with a logical erase group to be secure erased is deleted after receiving a command requesting to erase the data associated with the logical erase group.

### BRIEF DESCRIPTION OF THE DRAWINGS

FIG. 1 shows a block diagram of a secure erase system for a solid state memory device according to one embodiment of the present invention;

FIG. 2 shows data encryption and decryption by the encryption unit in FIG. 1;

FIG. 3A shows a flow diagram of reading data from a memory area;

FIG. 3B shows a flow diagram of writing data to a memory area;

FIG. 4A to FIG. 4D show a sequence of mappings between a logical block address (LBA) and a physical block address (PBA) in a writing example adopting a page level algorithm;

FIG. 5A to FIG. 5C show a sequence of mappings between the LBA and the PBA in another writing example adopting a block level algorithm;

FIG. 6 shows a flow diagram of secure erasing data according to one embodiment of the present invention; and

FIG. 7A and FIG. 7B show a secure erase example adopting the page level algorithm according to the embodiment of the present invention.

### DETAILED DESCRIPTION OF THE INVENTION

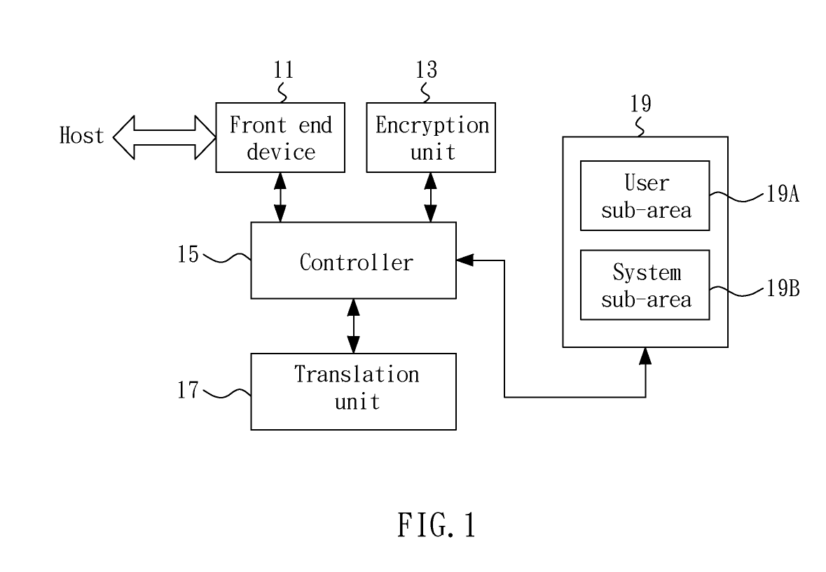

FIG. 1 shows a block diagram of a secure erase system for a solid state memory device according to one embodiment of the present invention. The solid state memory device may be a solid state non-volatile memory device such as, but not limited to, a NAND flash memory or a phase change memory.

In the embodiment, the secure erase system includes a front end device 11, an encryption unit 13, a controller 15, a translation unit 17 and a memory area 19. Specifically, the front end device 11 acts as an interface of the secure erase system to a host (such as a computer or a processor). Some of the common front end devices are Secured Digital (SD), MultiMediaCard (MMC), embedded MultiMediaCard (eMMC), Serial Advanced Technology Attachment (SATA), Peripheral Component Interconnect Express (PCIe), Integrated Drive Electronics (IDE), Universal Serial Bus (UBS), IEEE 1394 and SmartCard.

The memory area 19 may be divided into a user sub-area 19A and a system sub-area 19B. Each sub-area may be further divided into a number of blocks. The user sub-area 19A is ordinarily used, but not limited, to store user data, and the system sub-area 19B is ordinarily used to store system program and related parameters. It is appreciated by those skilled in the pertinent art that the division of the memory area 19 and the allocation of the divided sub-areas may be flexibly arranged according to specific applications.

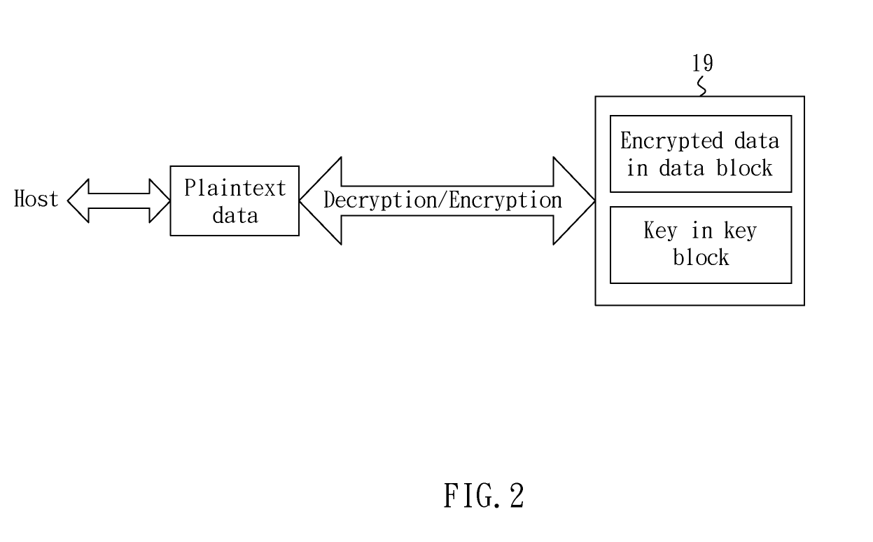

According to one aspect of the present embodiment, as shown in FIG. 2, the encryption unit 13 encrypts plaintext data to be written to the memory area 19 with an associated cryptographic key (or “key” for short), and decrypts the encrypted data (or ciphertext data) to be read by the host with the associated key. The encrypted data is stored in a data block of the memory area 19, and the key is stored in a key block of the memory area 19. It is noted that the data block and the key block may be disposed in the same or different groups of a sub-area (e.g., the user sub-area 19A), or may be disposed in the groups of different sub-areas respectively (e.g., the user sub-area 19A and the system sub-area 19B). In other words, the key block may be disposed in the user sub-area 19A, the system sub-area 19B or a spare region of the memory area 19.

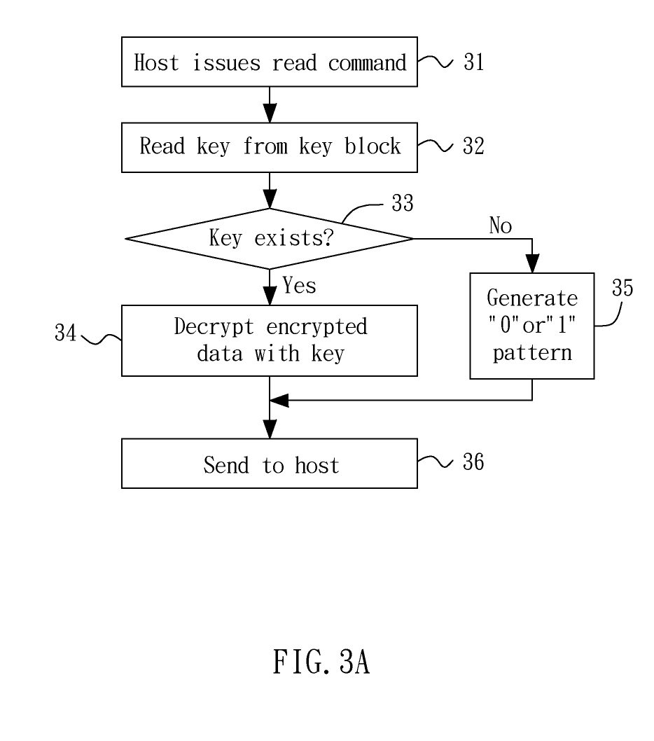

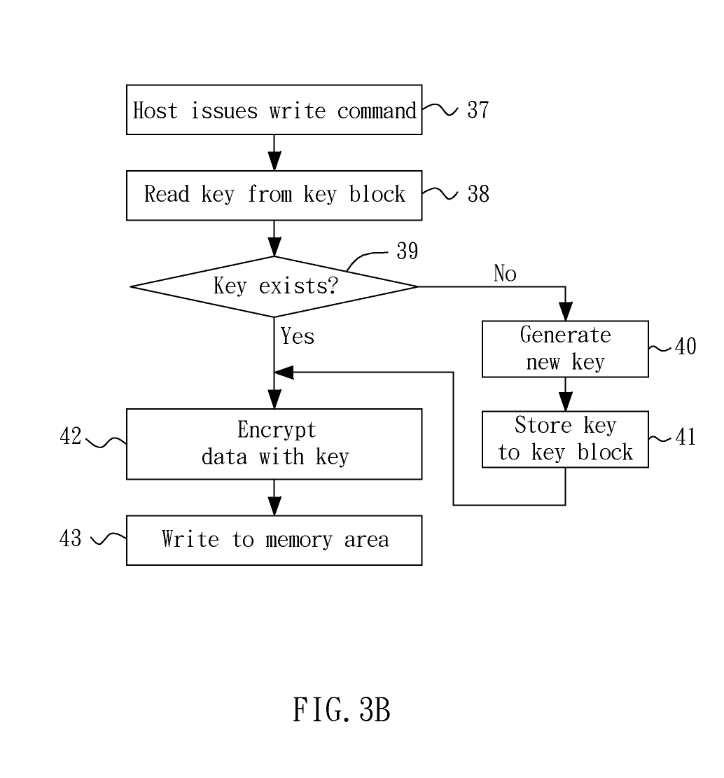

The encryption unit 13 of present embodiment adopts a symmetric-key algorithm that produces a single key for each data or each logical erase group, which may be generated, for example, by a hardware or software random number generator. The controller 15 supervises the front end device 11, the encryption unit 13 and the memory area 19 to read data from the memory area 19 to the host, or write data from the host to the memory area 19. FIG. 3A shows a flow diagram of reading data from the memory area 19, and FIG. 3B shows a flow diagram of writing data to the memory area 19.

With respect to data reading flow, as shown in FIG. 3A, the host firstly issues a read command (step 31). Subsequently, in step 32, the key stored in the key block is read by the controller 15. If the key exists already (step 33), the encrypted data stored in the memory area 19 is then decrypted by the encryption unit 13 with the key (step 34), otherwise, a predefined pattern such as all “0”, “1” or other pattern, which is different from the original data associated with the read command and indicates an invalid data or absence of data, is generated and filled in a buffer (step 35). Finally, in step 36, the decrypted data or the predefined pattern is sent to the host.

With respect to data writing flow, as shown in FIG. 3B, the host firstly issues a write command (step 37). Subsequently, in step 38, the key stored in the key block is read by the controller 15. If the key does not exist (step 39), a new key is generated (step 40), for example, by a random number generator, followed by storing the generated key to the key block (step 41). Subsequently, in step 42, the data is encrypted by the encryption unit 13 with the existing key or the generated key (step 42). Finally, in step 43, the encrypted data is written to the memory area 19.

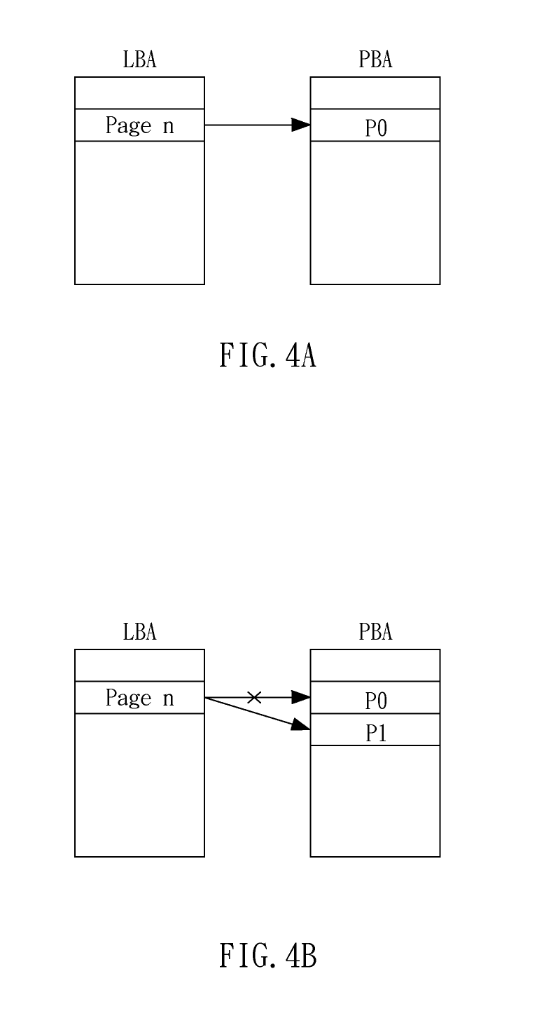

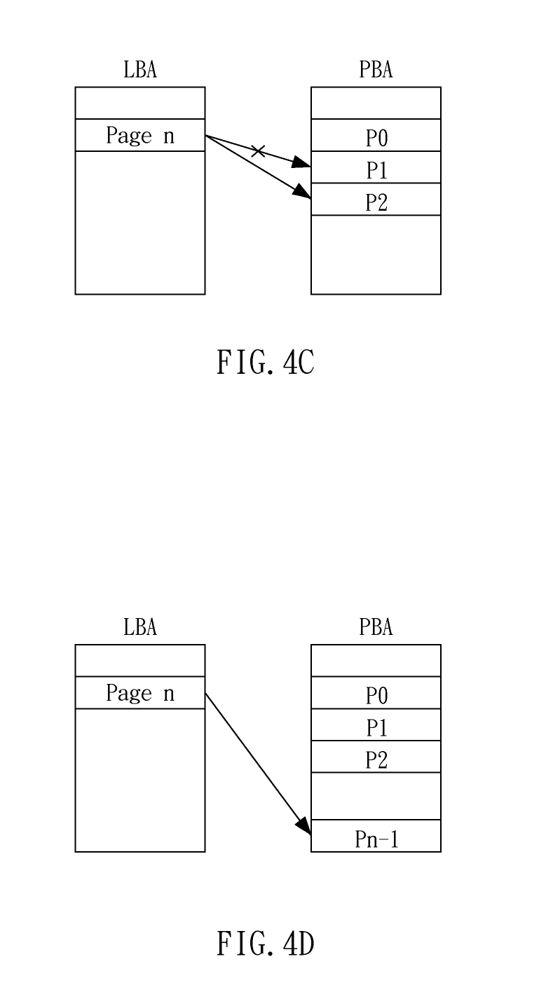

The translation unit 17 maps a logical block address (LBA) to a physical block address (PBA), for example, by a flash translation layer (FTL). The former is addressable by the host, and the latter is addressable by the controller 15. With respect to the flash memory, a page level algorithm and a block level algorithm are commonly used. FIG. 4A to FIG. 4D show a sequence of mappings between the LBA and the PBA in a writing example adopting the page level algorithm. In this extreme example, the host writes data to the memory area 19 at the same logical address for a number of times (e.g., n times). It is observed that, as the page level algorithm is a log-based algorithm, an updated page is relocated to a different physical address each time the host writes the data at the same logical address. As a result, totally n pages, from the oldest one to the newest one, occupy the memory area 19.

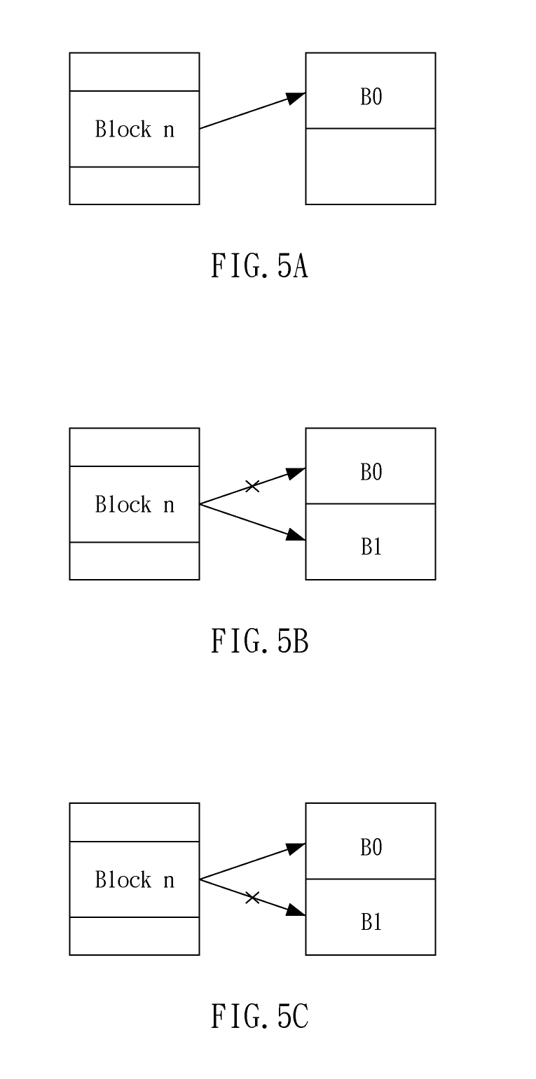

FIG. 5A to FIG. 5C show a sequence of mappings between the LBA and the PBA in another writing example adopting the block level algorithm. In this extreme example, the host writes data to the memory area 19 at the same logical address for a number of times (e.g., 3 times). It is observed that an updated page is alternately relocated to one of two physical addresses each time the host writes the data at the same logical address. As a result, two pages (i.e., the newest one and the previous one) occupy the memory area 19.

In either the page level algorithm (FIGS. 4A-4D) or the block level algorithm (FIGS. 5A-5C), multiple sets of data (or multiple data groups) have actually been resided in the memory area 19, if the host writes the data at the same logical address.

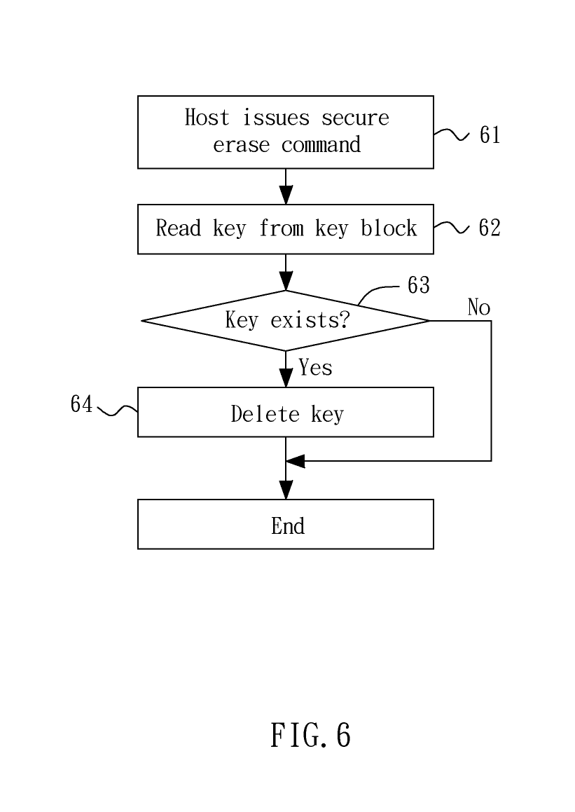

According to another aspect of the present embodiment, when the host issues a secure erase command, i.e., a command requesting to erase the data associated with the logical erase group, all those sets of data corresponding to the same logical address may be irreversibly erased by simply deleting the key associated with the data or associated with the logical erase group. Generally speaking, each logical erase group, which may be any data erase unit definable in the memory area 19, has an associated key. FIG. 6 shows a flow diagram of secure erasing data according to one embodiment of the present invention. Specifically, in step 61, the host firstly issues a secure erase command. Subsequently, in step 62, the key stored in the key block is read. If the key exists already (step 63), the key is then deleted, for example, by an erase command for the flash memory (step 64). As the key is deleted, the associated encrypted data is no longer recoverable without the key. Although the secure erase command is issued from the host in the exemplary embodiment, the secure erase command may be issued from the secure erase system itself (e.g., the controller 15).

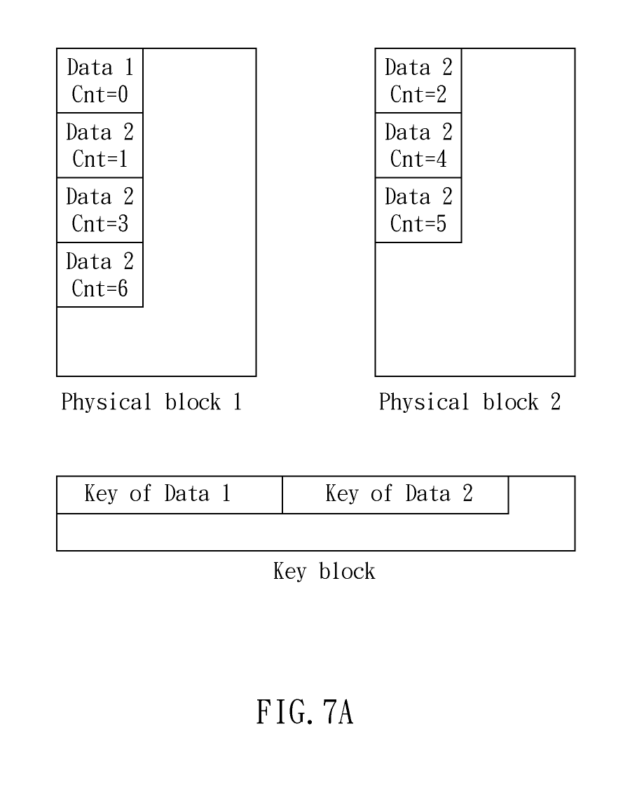

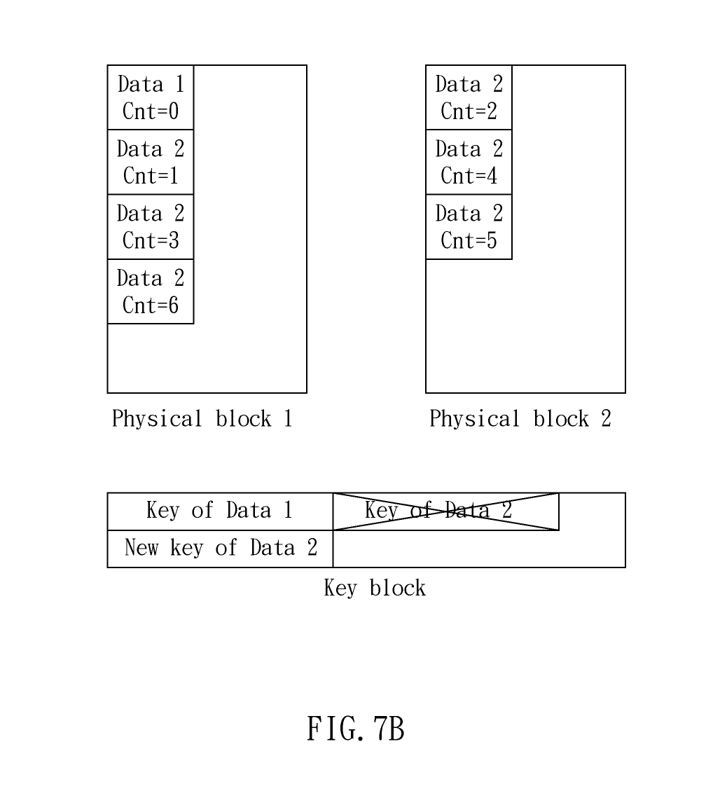

FIG. 7A to FIG. 7B show a secure erase example adopting the page level algorithm according to the embodiment of the present invention. Before the secure erasing, as shown in FIG. 7A, (encrypted) data 1 and data 2, which correspond to different logical addresses respectively, reside in a physical block 1 and block 2. The data with greater counter value Cnt is the data that has been written to the physical block at a later time. For example, the data 2 with Cnt=6 is written to the physical block 1 later than the data 2 with Cnt=5 is written to the physical block 2. Moreover, the data 1 and the data 2 have their associated keys respectively, which are stored in a key block.

After secure erasing the data 2, as shown in FIG. 7B, the associated key of the data 2 is deleted, and a new key is generated and stored. The new key may not be generated immediately after the associated key of the data 2 has been deleted, according to another embodiment. Instead, the new key may be generated by next write operation. As the key associated with the data 2 with Cnt=1 to 6 has been deleted, the associated data 2 is no longer recoverable without the key.

Accordingly, the secure erase system in the present embodiment performs at a substantially greater speed than the conventional technique that erases the data sets one by one.

Although specific embodiments have been illustrated and described, it will be appreciated by those skilled in the art that various modifications may be made without departing from the scope of the present invention, which is intended to be limited solely by the appended claims.

What is claimed is:

1. A secure erase system for a solid state memory device, the system comprising:
a memory area that provides a data block for storing data and a key block for storing at least one key;
a translation unit configured to map a logical address to a physical address associated with the memory area; and
an encryption unit configured to encrypt plaintext data to be written to the memory area with the associated key and decrypt the encrypted data to be read by a host with the associated key;
wherein the key associated with a logical erase group to be secure erased is deleted after receiving a command requesting to erase the data associated with the logical erase group.

2. The system of claim 1, wherein the solid state memory device is a solid state non-volatile memory device.

3. The system of claim 2, wherein the solid state non-volatile memory device is a flash memory or a phase change memory.

4. The system of claim 1, further comprising a front end device configured to act as an interface of the secure erase system.

5. The system of claim 4, wherein the front end device is one of the following: Secured Digital (SD), MultiMediaCard (MMC), embedded MultiMediaCard (eMMC), Serial Advanced Technology Attachment (SATA), Peripheral Component Interconnect Express (PCIe), Integrated Drive Electronics (IDE), Universal Serial Bus (UBS), IEEE 1394 and SmartCard.

6. The system of claim 1, wherein the memory area is divided into a user area for storing user data, and a system area for storing a system program and related parameters.

7. The system of claim 1, wherein the data block and the key block are disposed in same or different groups of a sub-area of the memory area.

8. The system of claim 1, wherein the data block and the key block are disposed in groups of different sub-areas of the memory area respectively.

9. The system of claim 1, wherein the key block is disposed in a user sub-area, a system sub-area or a spare region of the memory area.

10. The system of claim 1, wherein the encryption unit adopts a symmetric-key algorithm that produces the single key.

11. The system of claim 1, wherein the key is generated by a random number generator.

12. The system of claim 4, further comprising a controller configured to supervise the encryption unit, the front end device and the memory area to read data from the memory area to the host, or write data from the host to the memory area.

13. The system of claim 12, wherein the controller reads the key stored in the key block after receiving a read command, wherein the encrypted data stored in the memory area is decrypted with the key by the encryption unit and then sent to the host if the key exists, otherwise, a predefined pattern indicating an invalid data or absence of data is generated and then sent to the host.

14. The system of claim 12, wherein the controller reads the key stored in the key block after receiving a write command, wherein a new key is generated by the encryption unit and then stored in the key block if the key does not exist; data to be written is subsequently encrypted with the existing key or the new key, followed by writing the encrypted data to the memory area.

15. The system of claim 1, wherein the logical address is mapped to the physical address by a flash translation layer.

16. The system of claim 15, wherein the flash translation layer adopts a page level algorithm or a block level algorithm.

17. The system of claim 1, wherein the logical erase group is a data erase unit definable in the memory area.

18. The system of claim 1, wherein the requesting command is issued by the host.

19. The system of claim 12, wherein the requesting command is issued by the controller.

20. The system of claim 1, wherein the key is read from the key block after receiving the requesting command, followed by deleting the key if the key exists.
